(19) United States
(12) Patent Application Publication
(10) Pub. No.: US 2003/0049549 A1
(43) Pub. Date: Mar. 13, 2003

(54) Optical storage method for rewritable digital data carriers

(76) Inventors: Rainer Hagen, Leverkusen (DE); Thomas Bieringer, Odenthal (DE); Serguei Kostromine, Swisstal (DE); Horst Berneth, Leverkusen (DE)

Correspondence Address: BAYER CORPORATION, PATENT DEPARTMENT, 100 BAYER ROAD, PITTSBURGH, PA, 15205, US

(21) Appl. No.: 10/204,100

(22) PCT Filed: Feb. 6, 2001
(86) PCT No.: PCT/EP01/01236

(30) Foreign Application Priority Data
Feb. 18, 2000 (DE) 100 07 410.3

(51) Int. Cl. G11B 7/24

(52) U.S. Cl. 430/19; 430/945; 430/270.14; 428/64.8

(57) ABSTRACT

The present invention relates to a method by which items of digital information can be stored repeatedly by light induction in a two-dimensional medium and erased again, the items of information being optically readable.

The present invention relates to a method by which items of digital information can be repeatedly stored in a two-dimensional medium and erased again by light induction, the items of information being optically readable.

The technology of optical storage and read-out of digital data is already being intensively utilized commercially. The CD-R and the DVD-R in the audio or in the video format are interchangeable media that offer the possibility of one-off optical data storage. They are on the point of displacing the market-dominating data media audio CD and CD-ROM, in which the data are stored during the injection-moulding process of the medium material in the form of local depressions, the so-called pits (EP-A 25253). CD-R and DVD-R have a multilayer structure comprising a medium material composed in general of polycarbonate, a thin dyestuff layer and a reflecting layer that is composed in general of gold and is protected by a covering lacquer. The storage method is based on light-induced effects that occur as a result of focusing a laser through the substrate onto the functional layer that absorbs the laser light. The laser is guided in the tracking channels (so-called pregrooves) that have been impressed in the medium material and whose shape is simulated by the dyestuff layer. As a consequence of a sufficiently intensive laser pulse, the absorption behaviour of the dyestuff layer may be altered, for example by decomposition of molecules. Furthermore, the dyestuff layer may be heated locally at the position of the laser focus to such an extent that it modifies its environment. Blisters and other deformations occur at the boundary regions with the polycarbonate substrate and with the reflecting layer. Said local modifications can be read out by suitable optics as binary intensity patterns. Such storage media can be written only once because of the irreversibility of the modifications, but can be read out as often as required (write-once-read-many: WORM disk)

The re-writable CD-RW data media that have recently become available on the market likewise utilize in a controlled manner thermal effects at the focus of a writing laser: the different reflectivities of the amorphous and the crystalline states (phase change) are utilized in the case of thin layers of ternary or quaternary compounds (for example, composed of Te—Se—Sn or Ge—Sb—Te) that absorb the light of the writing laser.

It is possible to switch to and from between the two phases as a result of suitable heating and cooling processes that occur during and after a light pulse having a suitable intensity pattern or as a result of a suitable sequence of light pulses: the amorphous state is produced by sufficiently high laser powers that bring the material locally to a temperature higher than the material-specific melting point. The light pulse is followed by a rapid cooling of the material (quenching) to room temperature. The crystalline state, on the other hand, is formed from an isotropic orientation state at temperatures that are above the crystallization temperature, but below the melting point. The crystallization rate is material-dependent.

In particular, the once-writable systems described have two big disadvantages: on the one hand, the cost of the reflecting layer composed in general of gold decisively determined the production costs. Gold layers guarantee the required chemical inertness (oxidation resistance) and are necessary to satisfy the reflection values required in the CD specifications during read-out. On the other hand, there is a disadvantage in the storage stability, which is already limited in principle. The systems at present commercially available are, moreover, very sensitive to daylight.

An application-relevant potential for permanent digital data storage is exhibited by photoaddressable polymers or oligomers to whose polymer main chains photoactive azo dyestuffs are chemically attached as side groups. It is known from the literature that isomerization cycles in the azo dyestuffs that result in directional rearrangement of these dyestuff molecules can be stimulated by irradiation with polarized laser light. Consequently, large shape anisotropies, i.e. birefringences, can be built up and erased again. To use this effect for binary and/or multibit storage, the concept of “reverse writing” with pre-exposure (EP-A 900 239) is conventionally used. In this connection, the functional layer is first converted in a pre-exposure step into a birefringent initial state by means of the polarized light of a cw laser or a lamp. This step typically lasts a few seconds to minutes, depending on the intensity of the light source used. The speed of pre-exposure is determined for given exposure parameters by the photosensitivity of the functional layer.

In the layer preformatted in this way, the birefringences can be steplessly erased locally by pulsed exposure using the so-called writing laser according to the “reverse writing” principle. The different degrees of anisotropy can be converted by means of the depolarization of the light of a reading laser and suitable polarization optics into binary and also multibit signals.

The pre-exposure is characterized in that the light is not focused in a controlled manner on the functional layer so that a plurality of storage locations are achieved on the functional layer simultaneously. The intensities are typically between 0.01 and 10 W/cm².

The pulsed exposure is characterized in that the laser light is focused on the functional layer, while a laser scans the functional layer in the pulsed mode or in the continuous-wave (cw) mode. In the first case, a pulse or a pulse sequence having a suitable intensity pattern may be applied. In the second case, there must be a suitable intensity modulation of the cw laser. The exposure time in both cases is between 0.1 ns and 1000 ns, preferably between 1 and 200 ns, particularly preferably between 3 and 4 ns. Typically, intensities between 0.01 and 10 MW/cm² are achieved. Alternatively, the scanning of the laser may be dispensed with if a relative movement between medium and laser spot, for example by rotating the medium, is provided in another way.

The photosensitivity for the time range described is defined as the ratio of the birefringence value Δn inducible as a maximum by the pulsed exposure and the energy density E of the light.

The “reverse writing” is characterized by the pulsed exposure of the functional layer and describes the elimination of an existing birefringence. In this case, markedly higher intensities can be achieved than in the case of pre-exposure. The consequences are: the birefringence can be eliminated markedly more rapidly than in the case of pre-exposure; however, thermal effects that may result in a local temperature increase in the functional layer are also induced by the high intensities of the laser light.

Thermal effects can be utilized for said “reverse writing” insofar as they induce non-directional rotational dynamics of static origin in the side chains. The photosensitivities of the polymers are consequently largely irrelevant to the operating principle of this method.

To provide a once-writable storage medium, for example in the CD-R or DVD-R format, by means of the “reverse writing with pre-exposure” storage concept just described, the time-consuming pre-exposure step has to be incorporated into the production process of the data medium.

To provide a re-writable storage medium, for example in the CD-RW format, by means of said storage concept, the functional layer would either have to be formatted prior to every writing operation or a technologically complex synchronization of the two exposure steps described that makes possible a direct overwriting of information (“direct overwrite”) would have to be achieved.

The pre-exposure step could hitherto not be avoided since the buildup of birefringences by pulsed exposure, starting from the isotropic state of photoaddressable polymers or oligomers was not possible. As a consequence of the low photosensitivities, the inducible birefringence changes did not meet the technical requirements imposed on the signal/noise ratios during readout, i.e. the depolarization of a reading laser, which is converted by means of suitable optics into an intensity contrast between a pulsed-exposed and an isotropic unexposed point in the recording layer is too small to be able to decode the binary or multibinary items of information without error.

Increasing the birefringence changes by using higher intensities was unsuccessful since the pulsed exposure in the required intensity ranges results in a thermally induced destruction of the functional layer. There was therefore the need for an alternative, rapid storage method based on photoaddressable materials.

Surprisingly, it has been found that, with the choice of the laser source and the exposure conditions according to the invention, it is possible to induce, in photoaddressable polymers or oligomers according to the invention, birefringences by pulsed exposure. This principle is called “forward writing” because birefringences can be gradually built up by means of laser pulses starting from an isotropic state. Materials suitable for the method according to the invention are notable for a high speed in the directional molecular reorientation.

The application provides a method of storing digital binary or non-binary items of information in which a storage medium, comprising at least one substrate layer and at least one recording layer, is scanned by a focused laser beam that employs various energies and/or polarization states. The laser may operate in the pulse mode or by intensity modulation in the continuous-wave mode. Alternatively, the scanning of the laser may be dispensed with if a relative movement between medium and laser spot, for example by rotating the medium, can be provided in another way.

The application furthermore provides a method of optically writing, overwriting and erasing items of digital information that can be read out optically in a two-dimensional storage medium, wherein the optical writing process results in a buildup or elimination of birefringences in a recording layer without the recording layer being chemically decomposed or altered and without the surface topography of one of the layers of the storage medium being substantially altered.

“Forward writing” results in novel storage concepts. The pulsed exposure may be used to write and also to overwrite and/or erase data. A birefringence is written into an isotropic polymer matrix by means of a linearly polarized writing laser. The birefringence can be steplessly erased purely optically, for example by rotating the direction of polarization through 90° or by means of circularly polarized light. The level of the birefringence change induced by a pulse is adjusted by means of the pulse energy.

The degree of anisotropy of every storage location in the functional layer can be translated into a signal strength by means of a reading laser having a defined polarization state (linear, circular or elliptical) and an optical measurement system. The maximum contrast is achieved, for example, in the case of linear polarization if the polarization direction of the reading laser assumes 45° to the polarization of the forward writing pulses. Depending on the magnitude of the anisotropy, not only a binary, but also a multibit storage principle can be achieved that is based on graded signal levels, the so-called grey levels. The grey-level principle increases the amount of data compared with binary storage for the same number of storage locations.

In the case of binary storage, the method according to the invention makes possible writing speeds that are comparable with those of the CD-R. If N grey levels, where N=2^{m} (m is an integer greater than 1) is used, not only 1 bit can be stored in every storage location as in the case of binary storage, but m bits can be stored. Neglecting the time expended on decoding, the data transmission rate then increases by the factor m.

With the material selection according to the invention for the recording layer, this storage method is reversible to a good approximation. The grey levels for every storage location can be repeatedly increased or decreased by changing, for example, the direction of polarization and the pulse energies of the writing laser. Existing items of information can consequently be erased and/or overwritten.

The pulse energy in the case of “forward writing” must not exceed a material-specific threshold value that is between 0.1 and 1000 mJ/cm², preferably between 1 and 100 mJ/cm².

The birefringence can be eliminated by at least two purely photonic methods and at least one thermally aided method:

by means of a laser pulse whose polarization is rotated through 90° with respect to the forward direction and that does not exceed the energy threshold just described (photonic “reverse writing”).

by means of a laser pulse that is circularly polarized and whose energy does not exceed the threshold just described.

by means of a laser pulse that exceeds the threshold just described. The polarization state of the pulse is unimportant. Thermal effects that occur in the light focus can increase the level of the birefringence change.

The main requirement imposed on the storage material according to the invention is that it is photoactive for light in the visible wavelength range so that anisotropies, that is to say birefringence values, can be changed photonically. The material class according to the invention is notable for a high photosensitivity, preferably

$$\frac{Δ n}{E} ≧ 0.3 \frac{{cm}^{2}}{J}$$

in the wavelength range from 390 nm to 580 nm, preferably from 400 nm to 532 nm, particularly preferably from 514 nm to 532 nm, and also from 380 to 415 nm. The photosensitivity relates to light pulses of 0.1 ns to 1000 ns duration, preferably 1 to 200 ns, particularly preferably 3 to 4 ns, the photosensitivity being defined as the ratio of the birefringence value Δn induced as a maximum by a laser pulse and the energy density E of this light pulse. The photosensitization has to be high enough for the birefringence inducible by a laser pulse in “forward writing” to be at least 1%, preferably at least 3% of the value that can be achieved as a maximum by monochromatic irradiation with the linearly polarized light of a cw laser in the visible wavelength range (350 nm to 780 nm) and for the value of the induced birefringence to be greater than 0.03, preferably 0.08.

The writing wavelength is in the absorption range of the recording layer, in particular in the high-sensitivity range of the material class according to the invention.

The reading wavelength may either be equal to the writing wavelength or may be chosen as of longer wavelength. If the reading wavelength is in the high photosensitivity range of the recording layer, the chosen intensity must be less than 10%, preferably less than 5%, particularly preferably less than 1%, of the intensity of the writing laser.

Suitable as preferred materials were found to be polymers/oligomers to whose main chains side-group molecules of various kinds are chemically bound, wherein at least one kind that absorbs the light of the so-called writing laser. Preferable as side-group molecules are photoactive azo dyestuffs. It is known from the literature that high shape anisotropies can be built up in them by irradiation with polarized laser light and erased again.

The microscopic reasons for a high photosensitivity are:

a high photonic quantum yield for the transition of a dyestuff molecule (“chromophore”) from the stretched trans-state to the angular cis state.

a strong form anisotropy of the side-chain molecules measured on the basis of the ratio of the polarizability parallel to and perpendicular to the molecular axis.

a high degree of orientation, i.e. a high mobility of the side-chain molecules that makes possible directional dynamics having large angles of rotation relative to the polarization direction of the writing laser.

absorption bands that are matched to the wavelength of the reading laser and that result in a strong resonance sharpness of the birefringence value read out.

Any two-dimensional multilayer structure that comprises at least one substrate layer, preferably composed of polycarbonate, poly(methyl methacrylate) (PMMA) or hydrogenated polystyrene (h-PS), and at least one recording layer composed of the polymers/oligomers according to the invention may serve as storage medium. The recording layer has a thickness of 50 nm to 500 nm, preferably of 150 nm, to 250 nm, particularly preferably of 190 nm to 210 nm.

Any recording layer may optionally be surrounded by two layers (enhancement layers), preferably composed of silicon nitride (SiN). As a result of intensified multiple reflections of the light of the reading laser inside the recording layer, these result in higher reading signals.

Pregroove structures, i.e. sequences of depressions that fix and delineate the later storage locations, can be impressed by the layers adjoining the recording layer.

A further interlayer that is transparent to the light of the laser used can be inserted at any interface, preferably at the recording-layer/substrate-layer interface.

The underside of the storage medium is defined by the external substrate layer. The upper side is situated above it.

The stored items of information can be written or also read out by means of a laser from either the upper side or the lower side.

The stored items of information may be read out by means of a laser either in transmission or in reflection.

In the case of writing from the lower side and read out in reflection, a reflecting layer may cover the recording layer. The preferred material is gold. Alternatively, silver or aluminium may also be used. The reflecting layer has a typical thickness of 10-100 nM.

On the upper side of the storage medium there is optionally a protective layer, preferably composed of epoxy resin, that serves as UV protection and as protection against mechanical wear and tear.

The recording material that is preferred is:

in the case of groupings that interact with the electromagnetic radiation, an azo dyestuff. The material according to the invention consequently contains at least one azo dyestuff.

Azo dyestuffs have, for example, the following structure of Formula (I)

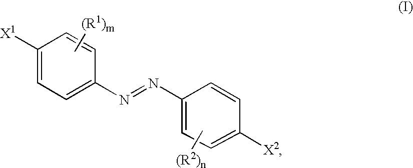

where

R¹ and R² stand, independently of one another for hydrogen or a nonionic substituent and

m and n stand, independently of one another for an integer from 0 to 4, preferably 0 to 2.

X¹ and X² denote —X^{1′}—R³ or X^{2′}—R⁴,

where

X^{1′} and X^{2′} stand for a direct bond, —O—, —S—, —(N—R⁵)—, —C(R⁶R⁷)—, —(C═O)—, —(CO—O)—, —(CO—NR⁵)—, —(SO₂)—, —(SO₂—O)—, —(SO₂—NR₅)—, —(C═NR⁸)— or —(CNR⁸—NR⁵)—,

R³, R⁴, R⁵ and R⁸ stand, independently of one another for hydrogen, C₁- to C₂₀-alkyl, C₃- to C₁₀-cycloalkyl, C₂- to C₂₀-alkenyl, C₆- to C₁₀-aryl, C₁- to C₂₀-alkyl-(C═O), C₃- to C₁₀-cycloalkyl-(C═O)—, C₂- to C₂₀-alkenyl-(C═O)—, C₆- to C₁₀-aryl-(C═O)—, C₁- to C₂₀-alkyl-(SO₂)—, C₃- to C₁₀-cycloalkyl-(SO₂)—, C₂- to C₂₀-alkenyl-(SO₂)— or C₆- to C₁₀-aryl-(SO₂)—, or

X^{1′}—R³ and X^{2′}—R⁴ may stand for hydrogen, halogen, cyano, nitro, CF₃ or CCl₃,

R⁶ and R⁷ stand, independently of one another for hydrogen, halogen, C₂- to C₂₀-alkyl, C₁- to C₂₀-alkoxy, C₃- to C₁₀-cycloalkyl, C₂- to C₂₀-alkenyl or C₆- to C₁₀-aryl.

Nonionic substituents are to be understood as meaning halogen, cyano, nitro, C₁- to C₂₀-alkyl, C₁- to C₂₀-alkoxy, phenoxy, C₃- to C₁₀-cycloalkyl, C₂- to C₂₀-alkenyl or C₆- to C₁₀-aryl, C₁- to C₂₀-alkyl-(C═O)—, C₆- to C₁₀-aryl-(C═O)—, C₁- to C₂₀-alkyl-(SO₂)—, C₁- to C₂₀-alkyl-(C═O)—O—, C₁- to C₂₀-alkyl-(C═O)—NH—, C₆- to C₁₀-aryl-(C═O)—NH—, C₁- to C₂₀-alkyl-O—(C═O)—, C₁- to C₂₀-alkyl-NH—(C═O)— or C₆- to C₁₀-aryl-NH—(C═O)—.

The alkyl, cycloalkyl, alkenyl and aryl radicals may be substituted for their part by up to three radicals from the series comprising halogen, cyano, nitro, C₁- to C₂₀-alkyl, C₁- to C₂₀-alkoxy, C₃- to C₁₀-cycloakyl, C₂- to C₂₀-alkenyl or C₆- to C₁₀-aryl and the alkyl and alkenyl radicals may be straight-chain or branched.

Halogen is to be understood as meaning fluorine, chlorine, bromine and iodine, in particular fluorine and chlorine.

The recording material according to the invention is preferably a polymeric or oligomeric organic, amorphous material, particularly preferably a side-chain polymer.

The main chains of the side-chain polymers originate from the following basic structures: polyacrylate, polymethacrylate, polysiloxane, polyurea, polyurethane, polyester or cellulose. Preferred are polyacrylate and polymethacrylate.

The dyestuffs, in particular the azo dyestuffs of Formula (I) are covalently bound to these polymer skeletons, as a rule via a spacer. For example, X¹ (or X²) then stands for such a spacer, in particular with the meaning X^{1′}—(Q¹)ᵢ-T-S¹—,

where

X^{1′} has the meaning specified above,

Q stands for —O—, —S—, —(N—R⁵)—, —C(R⁶R⁷)—, —(C═O)—, —(CO—O)—, —(CO—NR⁵)—, (SO₂), —(SO₂—O)—, —(SO₂—NR⁵)—, —(C═NR⁸)—, —(CNR⁸—NR⁵)—, —(CH₂)ₚ—, p- or m-C₆H₄— or a divalent radical of the formulae

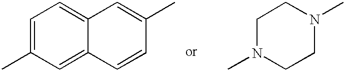

i stands for an integer from 0 to 4, wherein the individual Q¹s may have different meanings for i>1,

T¹ stands for —(CH₂)ₚ—, wherein the chain may be interrupted by —O—, —NR⁹—, or —OSiR¹⁰₂O—,

S¹ stands for a direct bond, —O—, —S— or —NR⁹—,

p stands for an integer from 2 to 12, preferably 2 to 8, in particular 2 to 4,

R⁹ stands for hydrogen, methyl, ethyl or propyl,

R¹⁰ stands for methyl or ethyl and

R⁵ to R⁸ have the meaning specified above.

Preferred dyestuff monomers for polyacrylates or polymethacrylates then have Formula (II)

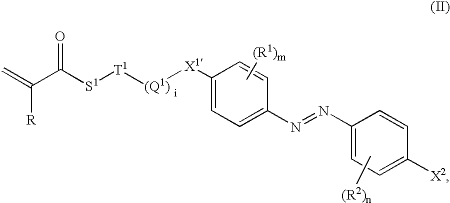

where

R stands for hydrogen or methyl

and the other radicals have the meaning specified above.

In addition to the dyestuffs, for example of Formula (I), the polymeric or oligomeric organic, amorphous material according to the invention may carry form-anisotropic groupings. These, too, are covalently bound, as a rule via a spacer, to the polymer skeletons.

Form-anisotropic groupings have, for example, the structure of Formula (III)

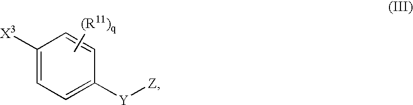

where Z stands for a radical of the formulae

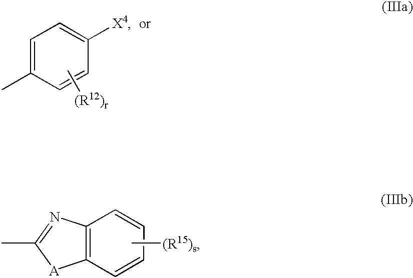

where

A stands for O, S or N—C₁ to C₄-alkyl,

X³ stands for —X^{3′}—(Q²)ⱼ-T²-S²—,

X⁴ stands for X⁴′—R¹³,

X^{3′} and X^{4′} stand, independently of one another, for a direct bond, —O—, —S—, —(N—R⁵)—, —C(R⁶R⁷)—, —(C═O)—, —(CO—O)—, —(CO—NR⁵)—, —(SO₂)—, —(SO₂—O)—, —(SO₂—NR⁵)—, —(C═NR⁸)— or —(CNR⁸—NR⁵),

R⁵, R⁸ and R¹³ stand, independently of one another, for hydrogen, C₁- to C₂₀-alkyl, C₃- to C₁₀-cycloalkyl, C₂- to C₂₀-alkenyl, C₆- to C₁₀-aryl, C₁- to C₂₀-alkyl-(C═O)—, C₃- to C₁₀-cycloalkyl-(C═O)—, C₂- to C₂₀-alkenyl-(C═O)—, C₆- to C₁₀-aryl-(C═O)—, C₁- to C₂₀-alkyl-(SO₂)—, C₃- to C₁₀-cycloalkyl-(SO₂)—, C₂- to C₂₀-alkenyl-(SO₂)- or C₆- to C₁₀-aryl-(SO₂)-, or

X^{4′}-R¹³ may stand for hydrogen, halogen, cyano, nitro, CF₃ or CCl₃,

R⁶ and R⁷ stand, independently of one another, for hydrogen, halogen, C₁- to C₂₀-alkyl, C₁- to C₂₀-alkoxy, C₃- to C₁₀-cycloalkyl, C₂- to C₂₀-alkenyl or C₆- to C₁₀-aryl,

Y stands for a single bond, —COO—, OCO—, —CONH—, —NHCO—, —CON(CH₃), —N(CH₃)CO—, —O—, —NH— or —N(CH₃)—,

R¹¹, R¹², R¹⁵ stand, independently of one another, for hydrogen, halogen, cyano, nitro, C₁- to C₂₀-alkyl, C₁- to C₂₀-alkoxy, phenoxy, C₃- to C₁₀-cycloalkyl, C₂- to C₂₀-alkenyl or C₆- to C₁₀-aryl, C₁- to C₂₀-alkyl-(C═O)—, C₆- to C₁₀-aryl-(C═O)—, C₁- to C₂₀-alkyl-(SO₂)—, C₁- to C₂₀-alkyl-(C═O)—O—, C₁- to C₂₀-alkyl-(C═O)—NH—, C₆- to C₁₀-aryl-(C═O)—NH—, C₁- to C₂₀-alkyl-O—(C═O)—, C₁- to C₂₀-alkyl-NH—(C═O)— or C₆-to C₁₀-aryl-NH—(C═O)—,

q, r and s stand, independently of one another, for an integer from 0 to 4, preferably 0 to 2,

Q² stands for —O—, —S—, —(N—R⁵)—, —C(R⁶R⁷)—, —(C═O)—, —(C O—O)—, —(CO—NR⁵)—, —(SO₂)—, —(SO₂—O—)—, —(SO₂—NR⁵)—, —(C═NR⁸)—, —(CNR⁸—NR⁵)—, —(CH₂)ₚ—, p- or m-C₆H₄ or a divalent radical of the formulae

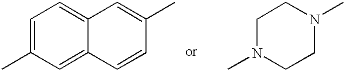

j stands for an integer from 0 to 4, wherein the individual Q's may have different meanings for j>1,

T² stands for —(CH₂)ₚ—, wherein the chain may be interrupted by —O—, —NR⁹—, or —OSiR¹⁰₂O—,

S² stands for a direct bond, —O—, —S— or —NR⁹—,

p stands for an integer from 2 to 12, preferably 2 to 8, in particular 2 to 4,

R⁹ stands for hydrogen, methyl, ethyl or propyl and

R¹⁰ stands for methyl or ethyl.

### EXAMPLES

### Example 1

Buildup and Elimination of Birefringence by Forward Writing and Reverse Writing

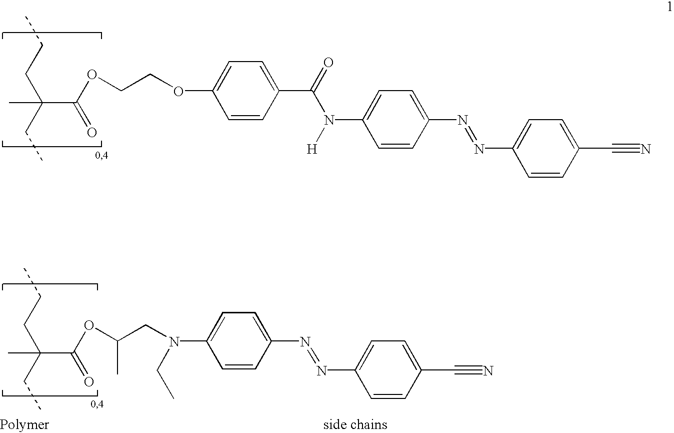

A 1 mm-thick glass substrate is provided with a thin layer of Polymer 1. This is done with the aid of spin coating. In this process, the polymer is dissolved in tetrahydrofuran at a concentration of 50 g/l and the solution is applied in drops to the substrate, which is rotating at a rotational speed of 2000 min⁻¹. The polymer film produced has a thickness of 680 mm. The remnants of the solvent are removed from the film by storing the coated glass supports at 60° C. for 2 h in a vacuum oven.

Birefringences Δn can be induced by means of pulse sequences in the originally isotropic polymer layer with an optical structure. An opto-parametric oscillator that is pumped by a frequency-doubled Nd:YAG laser having the wavelength 532 nm and emits at the wavelength 514 nm serves as light source. Light pulses of 4 ns duration can be emitted with a repetition rate of 10 Hz. The light is linearly polarized and serves to write the birefringence. The writing beam passes through a homogenizer that supplies a uniform intensity at the specimen position (vertical incidence). The pulse energy at the specimen position is 6.5 mJ/cm².

An HeNe laser (output power 2 mW, intensity at specimen position: 1 mW/cm², angle of incidence 10°) is used as reading laser. The reading polarization is rotated through 45° with respect to the writing polarization. The diode signal is recorded under computer control downstream of an analyser oriented perpendicularly to the reading polarization (signal Iₛ(t)). The signal is determined for every unexposed polymer layer on the unexposed specimen downstream of the analyser oriented parallel to the incident reading polarization (Iₚ⁰). The birefringence is determined from the relationship

$$Δ n ( t ) = \frac{633 nm}{d π} arcsin \sqrt{\frac{{I}_{s} ( t )}{{I}_{p}^{o}}}$$

(d is the polymer layer thickness).

After preparation, the polymer layer is isotropic in the plane of the film. The optical density at the writing wavelength is 1.34; at the reading wavelength, it is less than 0.02. By means of the writing light, trans-cis-trans isomerization cycles are induced in the absorbing side-group molecules, which leads to a buildup of a net orientation of the molecules away from the polarization direction of the laser (“forward writing”). These molecular dynamics manifest themselves macroscopically in a developing birefringence Δn=n_{y}−nₓ in the plane of the polymer film. The refractive index in the direction of polarization of the laser light (nₓ) falls during this process, whereas the refractive index perpendicular to the polarization direction (n_{y}) increases. A birefringence that saturates at a maximum value of between 0.04 and 0.06 gradually forms as a result of a sequence of laser pulses.

Δn is erased by rotating the direction of polarization of the writing light through 90° (“reverse writing”). This erasure operation is terminated as soon as Δn=0. This is equivalent to a value of Iₛ=0, which is detected by means of a diode.

A further writing operation immediately follows the first according to the same pattern. The birefringence saturates at a value that is comparable with that of the first writing operation within the framework of the measurement accuracy.

### Example 2

Energy Dependence of the Birefringence Changes During Forward Writing

The optical buildup described in Example 1 is used to record the dependence of the level of the birefringence changes on the pulse energy. A 335 nm-thick layer of the polymer shown is investigated.

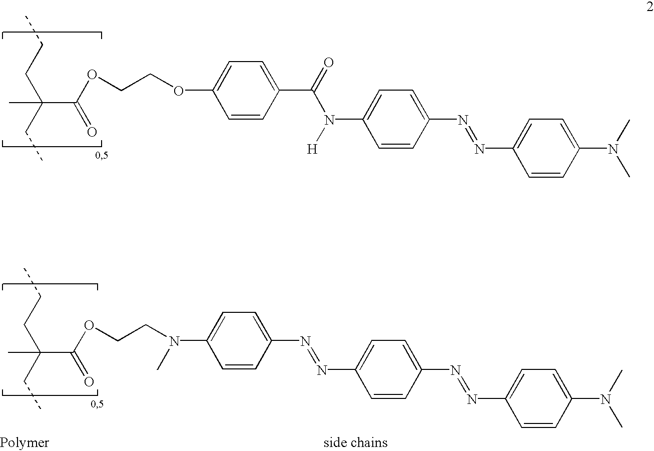

The birefringence induced after a linearly polarized light pulse is read out at the wavelength 633 nm. The energy density E of the pulse (intensity×pulse duration is varied between 2 and 18 mJ/cm². The statistical fluctuations in the pulse energy E are utilized in a controlled manner to obtain the functional relationship Δn(E) from the data obtained. For low energies, neutral-density filters are additionally used.

The intensity of the pulse is detected simultaneously with the reading operation. For this purpose, some of the writing beam is coupled out via a beam splitter upstream of the specimen and directed onto a photodiode.

Because of apparatus factors, a plurality of pulses is supplied to an originally isotropic point in the polymer layer. In order not to falsify the evaluation of Δn(E) by saturation effects in the anisotropy of the polymer, care is taken that the birefringence produced remains less than 10% of the value achievable as a maximum by exposure to a cw writing laser (Δn=0.3; writing wavelength 514 nm; writing intensity 100 mW/cm 2; reading wavelength 633 nm).

The pattern of Δn(E) shows, as a good approximation, a linear behaviour for Polymer 2, provided the chosen energy densities of the forward-writing pulses are less than 10 mJ/cm². In this energy range, birefringence changes of up to Δn=(3.3±0.3)·10⁻³ are induced. At energy densities above 10 mJ/cm², a deviation from linear behaviour towards smaller Δn values can be detected. The forward-writing process is impeded. The reason may be of a photonic or, alternatively, of a thermal nature, for example a strong local heating of the polymer which produces non-directional orientation relaxations or an incipient surface damage to the polymer layer.

Further examples of polymer/copolymers that are preferably used in the method according to the invention and that were prepared according to the general synthesis specifications described in EP-A 823 442.

Example A (x:y=60:40)

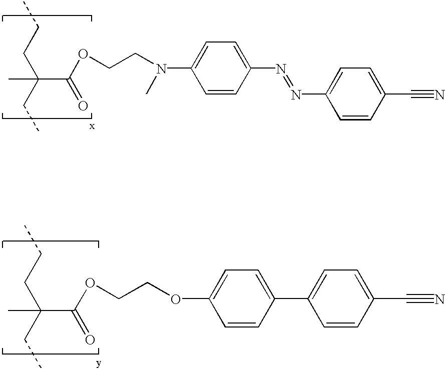

Example B (x:y=40:60)

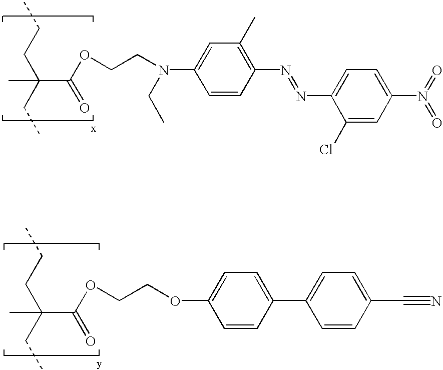

Example C (x:y=40:60)

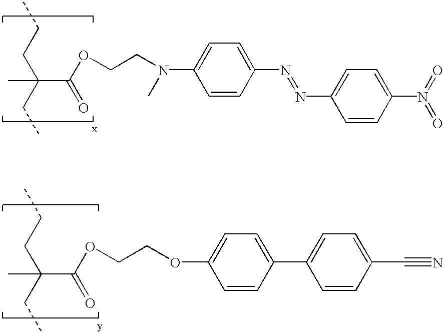

Example D

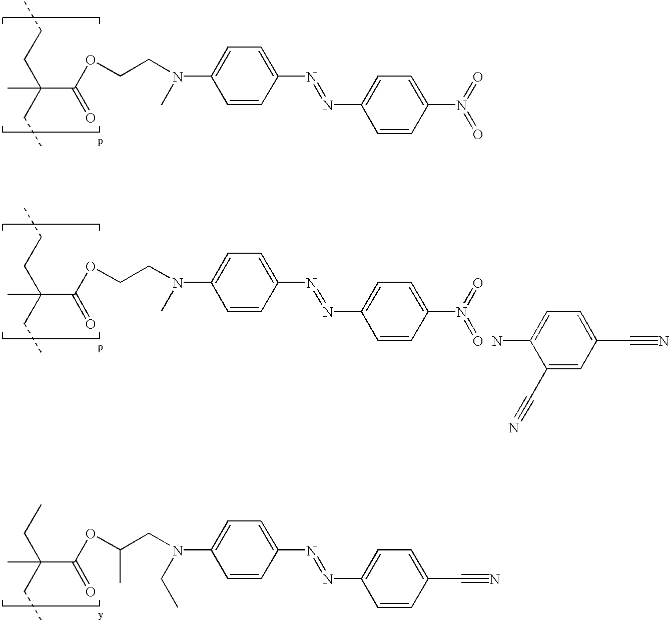

Example F (x:y=40:60)

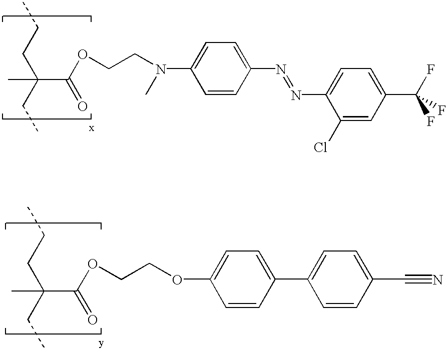

Example G (x:y=50:50)

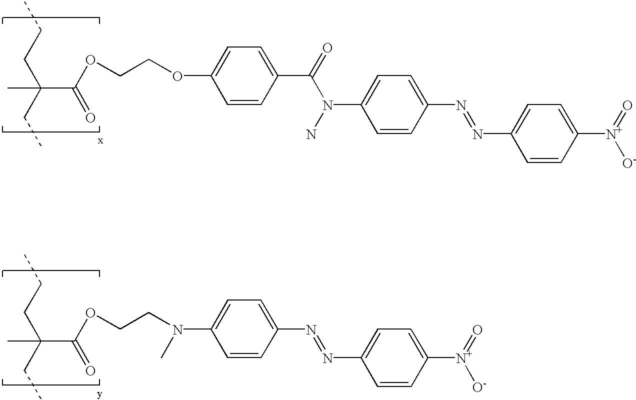

Example H (x:y=30:70)

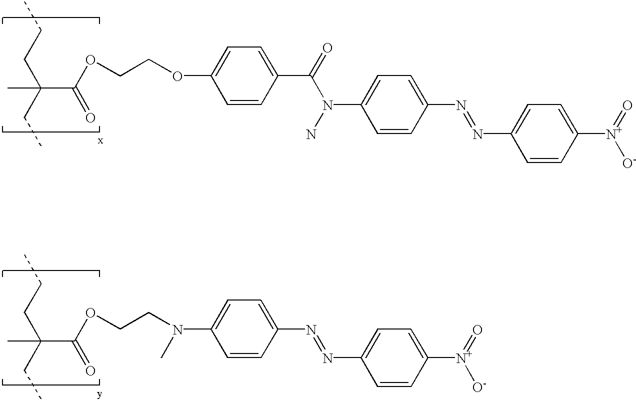

Example I (x:y=50:50)

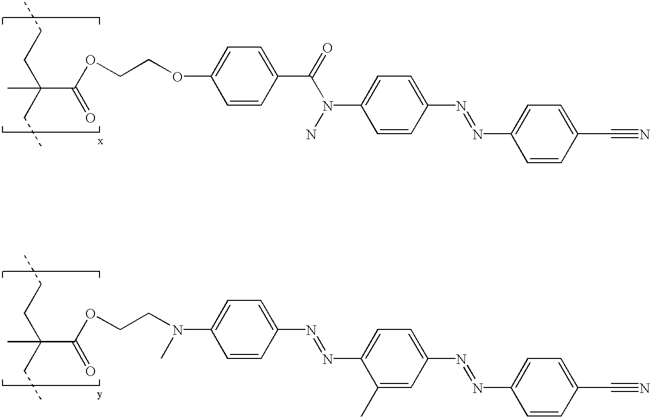

Example J (x:y=50:50)

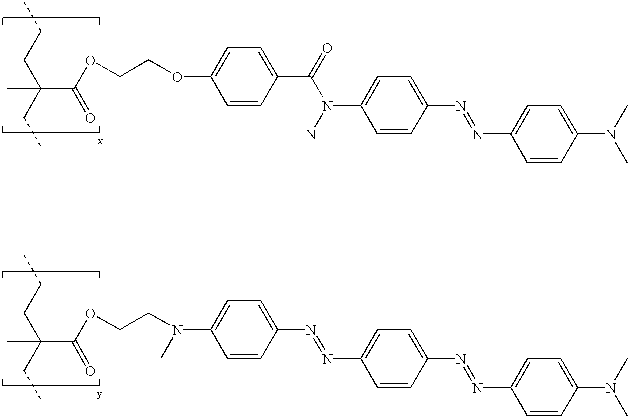

Example K

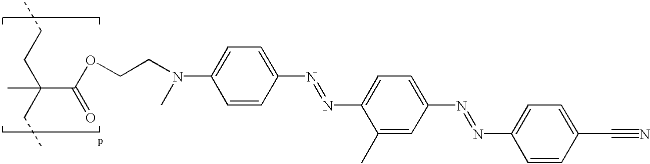

Example L

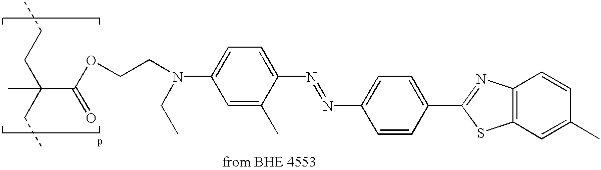

Example M

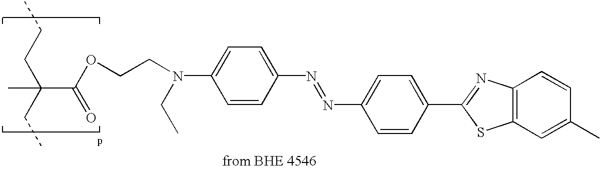

Example N (x:y=50:50)

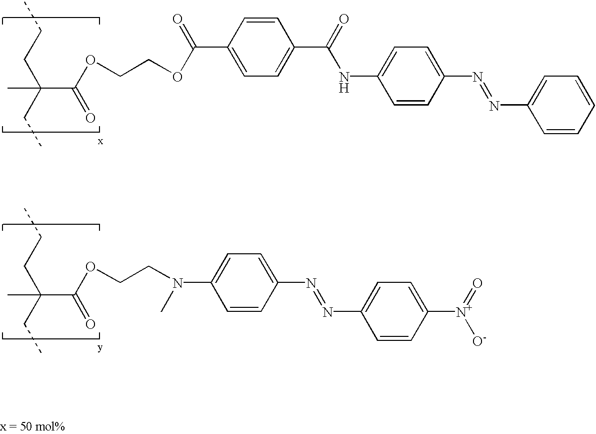

Example O (x:j=50:50)

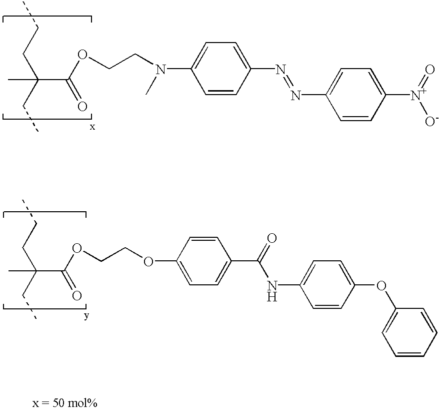

Example P (x:y=50:50)

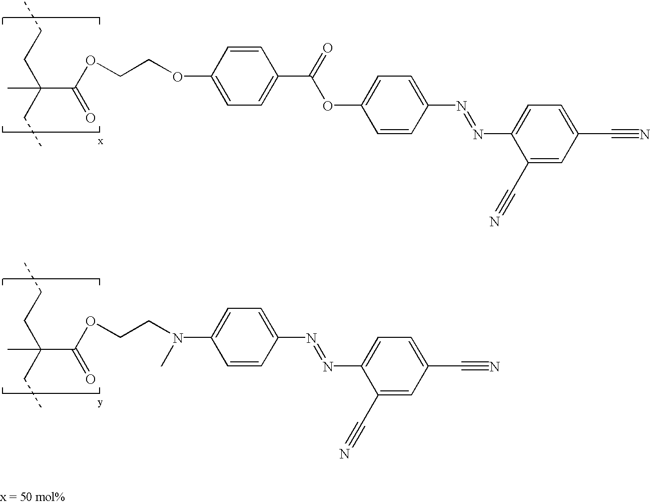

Example Q

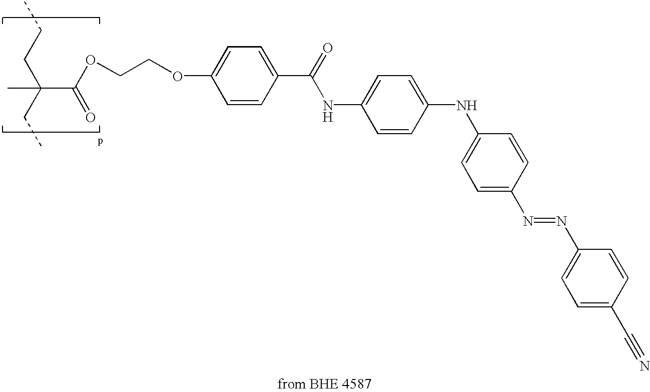

Example R

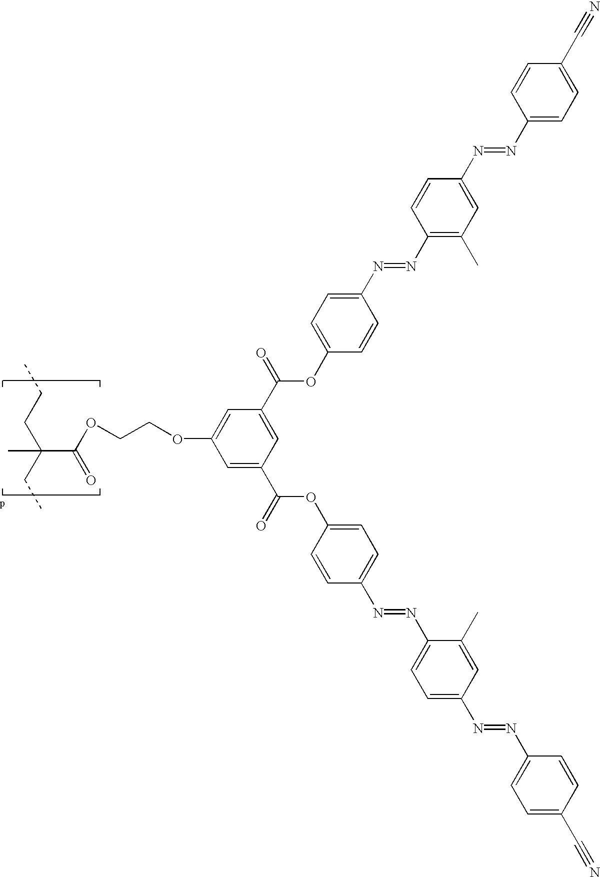

Example S

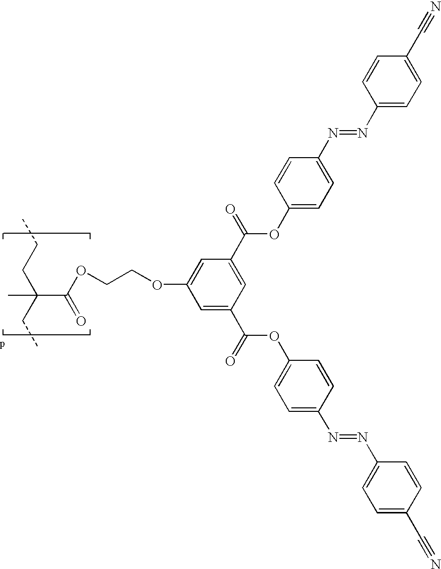

Example T

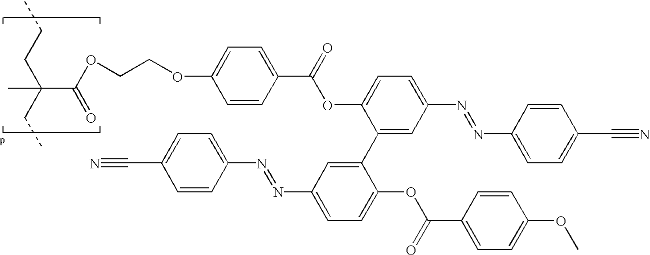

Example U

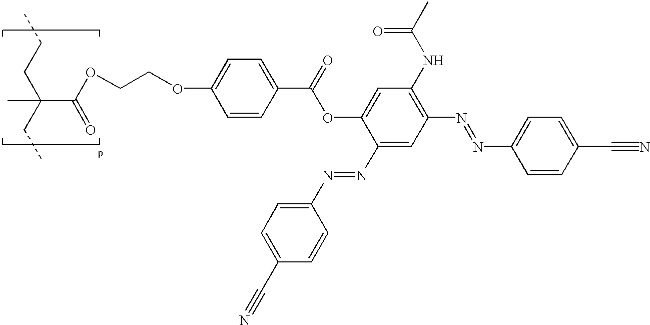

Example V

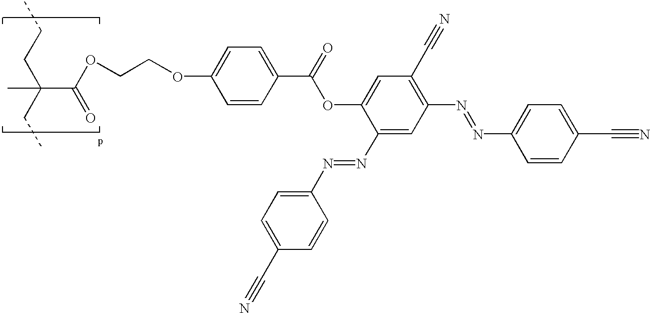

Example W (x:y=50:50)

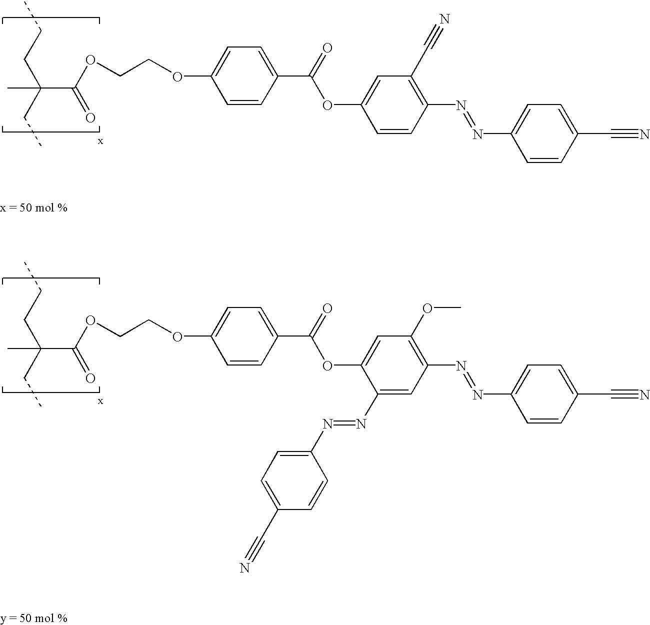

Example X (x:y=50:50)

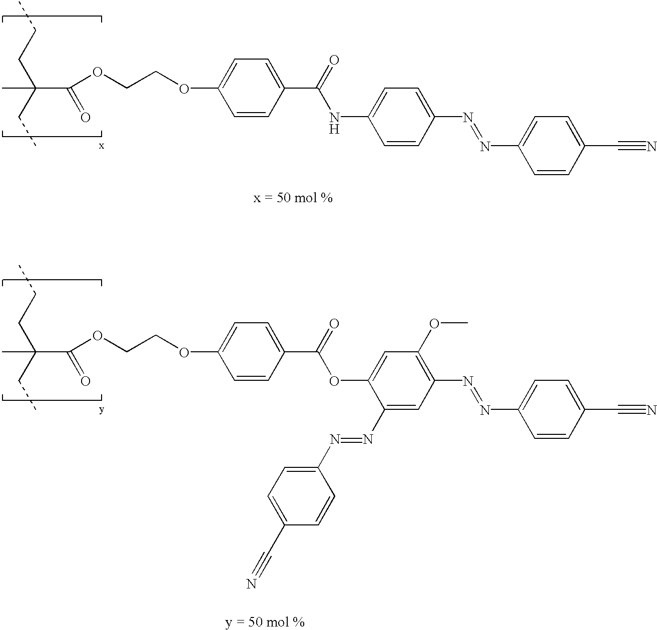

Example Y

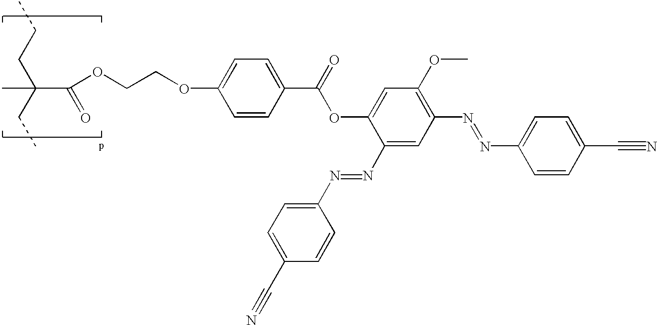

Example Z

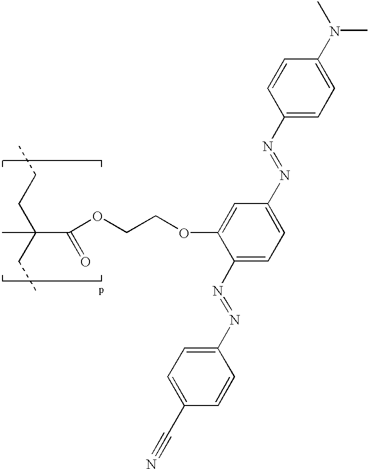

Special monomer synthesis of

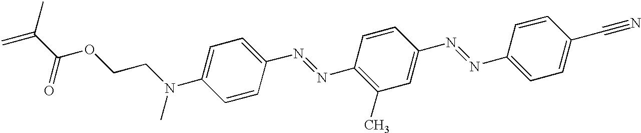

N-methyl-N-(2-methacryloyloxyethyl)-aniline

Variant from Methacryl Chloride:

100 g of N-methyl-N-(2-hydroxyethyl)aniline are dissolved in 100 ml of chloroform. 182.6 g of triethylamine and 137.2 g of methacryl chloride are slowly added dropwise while stirring at 40° C. and stirring is continued at 40° C. overnight. 500 ml of chloroform is then added to the reaction solution and the solution is extracted 5 times with 200 ml of water in each case. The organic phase is dried over anhydrous magnesium sulfate, copper(I) chloride is added and, after the solvent has been distilled off, distillation is performed in high vacuum. The methacrylic ester of hydroxyethylaniline distils as a water-clear liquid at 127-130° C./55 mbar. The yield is 49.5 g.

Variant from Methacrylic Acid:

50 ml of conc. sulfuric acid are added dropwise to a solution of 100 ml of N-methyl-N-(2-hydroxyethyl)aniline, 265 ml of methacrylic acid and 26.5 g of hydroquinone in 398 ml of chloroform at room temperature while stirring. After standing overnight, the solution is heated and the water of reaction is azeotropically removed. After cooling, a pH of 7 to 8 is established with concentrated aqueous soda solution and the product is extracted from this solution by shaking with ether. The subsequent procedure is as specified above and a yield of 56 g is obtained.

4-amino-3-methyl-4′-cyanoazobenzene is Prepared as Follows:

37.5 g of 4-cyanoaniline are dissolved in 200 ml of water at 60° C. 20 ml of 37% hydrochloric acid are added to this solution and stirring is performed until solution is complete. This solution is cooled to 0° C. and the remaining 230 ml of 37% hydrochloric acid are slowly added. While maintaining a temperature of 0-5° C., 104.5 g of 40% nitrosylsulfuric acid are added dropwise within 45 min. Stirring is continued for 2 h at 0-5° C.

89 ml of 37% sodium hydrogensulfite solution and 35 ml of 37% formaldehyde are introduced at 60° C. into a 10 l four-neck flask. 34 g of o-toluidine are added at this temperature and stirring is performed for 2 h. 1000 ml of water are now added to this solution and stirring is again performed at 60° C. for 30 min. The solution is cooled to 10-15° C. with external cooling (ice bath).

The diazonium salt solution is transferred to a dispensing funnel. While maintaining a temperature of 10-20° C., the diazonium salt solution is slowly allowed to drain into the solution described above. During the addition of the diazonium salt solution, 250 ml of 45% sodium hydroxide solution are added to raise the pH. The pH is raised to 5 by adding 600 ml of 20% sodium hydroxide solution. Stirring is continued for 1 h.

1100 ml of 45% sodium hydroxide solution are slowly added while cooling in an ice bath. The coupling solution is now stirred overnight at room temperature.

While cooling in an ice bath, 1720 ml of hydrochloric acid are added to achieve a pH of 10-10.3. Stirring is performed briefly (approximately 30 min). The precipitate is filtered off, rinsed with water and the residue is dried in a vacuum drying oven at 50° C. The yield is 67.9 g (89%).

57.7 g of 4-amino-3-methyl-4′-cyanoazobenzene in 300 ml of water are introduced into a 1 l three-neck flask and 150 ml of 96% hydrochloric acid are slowly added while cooling. While maintaining a temperature of 0-5° C., 99 g of nitrosylsulfuric acid (40 wt. %) are added dropwise within 40 min. Stirring is continued for 1 h at 0-5° C.

53.5 g of N-methyl-N-(2-methacryloyloxyethyl)aniline in 1500 ml of isopropanol are introduced into a 4 l four-neck flask. The diazonium salt solution is transferred to a dispensing funnel. While maintaining a temperature of 10° C. and a pH of 2-2.5, which is maintained by simultaneous addition of up to approximately 1.7 l of 15% sodium hydroxide, the diazonium solution is now added slowly. Stirring is continued for 1 h. The precipitate is filtered off, washed with a small amount of isopropanol and a large amount of water and the residue is dried in a drying oven at 60° C. The yield is 69 g (61%). Mp 161° C. λₘₐₓ=503.5 nm (DMF). ε=35300 l/(mol×cm).

Elemental analysis: C₂₇H₂₆N₆O₂ (466.55) calc.: C69.51; H5.62; N18.01; exp.: C69.00; H5.80; N18.00;

Polymer Syntheses:

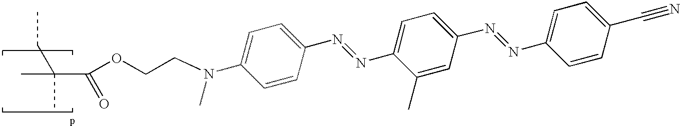

10.0 g of the monomer described in Example 1 are dissolved in 90 ml of N-methyl-2-pyrrolidone at 70° C. After the monomer has dissolved, flushing is performed for a further half-hour with argon, then 0.2 g of 2,2′azoisobutyril dinitrile in 2.0 ml of NMP and this solution is stirred for 2 days with argon flowing. The final solution is added dropwise to a 2 l beaker containing 700 ml of water and stirring is continued for half an hour. The precipitate is then filtered off. The product is boiled in 100 ml of methanol for half an hour under reflux and the methanol solution is poured off. This operation is repeated a twice more. The final product is dried in vacuo. Yield: 7.0 g (70% of theory).

1. Method of storing digital binary or non-binary items of information in which a storage medium, comprising at least one substrate layer and at least one recording layer, is scanned by a focused laser beam that operates in the pulse mode or by intensity modulation in the continuous-wave mode with various pulse energies and/or polarization states, characterized in that the recording layer is not pre-exposed and birefringences are produced by one or more pulses, wherein, alternatively, the scanning of the laser can be dispensed with if a relative movement between medium and laser spot can be provided in another way.

2. Method according to claim 1, of optically writing, overwriting and erasing items of digital information that can be read out optically in a two-dimensional storage medium, wherein the optical writing process results in a buildup or elimination of birefringences in a recording layer without the recording layer being chemically decomposed or altered and without the surface topography of one of the layers of the storage medium being substantially altered.

3. Method according to claim 1 and/or 2, wherein the recording material comprising a chemically bound dyestuff or Formula (I): 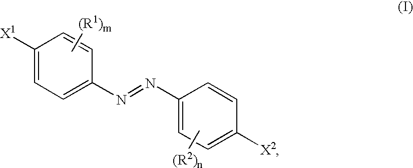
where
R¹ and R² stand, independently of one another for hydrogen or a nonionic substituent and
m and n stand, independently of one another for an integer from 0 to 4, preferably 0 to 2, and
X¹ and X² denote —X¹—R³ or X^{2″}—R⁴,
where
X^{1′} and X^{2′} stand for a direct bond, —O—, —S—, —(N—R⁵)—, —C(R⁶R⁷)—, —(C═O)—, —(CO—O)—, —(C O—NR⁵)—, —(SO₂)—, —(SO₂—O)—, —(SO₂—NR⁵)—, —(C═NR⁸)— or —(CNR⁸—NR⁵)—,
R³, R⁴, R⁵ and R⁸ stand, independently of one another for hydrogen, C₁- to C₂₀-alkyl, C₃- to C₁₀-cycloalkyl, C₂- to C₂₀-alkenyl, C₆- to C₁₀-aryl, C₁- to C₂₀-alkyl-(C═O), C₃- to C₁₀-cycloalkyl-(C═O)—, C₂- to C₂₀-alkenyl-(C═O)—, C₆- to C₁₀-aryl-(C═O)—, C₁- to C₂₀-alkyl-(SO₂)—, C₃- to C₁₀-cycloalkyl-(SO₂)—, C₂- to C₂₀-alkenyl-(SO₂)- or C₆- to C₁₀-aryl-(SO₂)—, or
X^{1′}—R³ and X^{2′}—R⁴ may stand for hydrogen, halogen, cyano, nitro, CF₃ or CCl₃,
R⁶ and R⁷ stand, independently of one another for hydrogen, halogen, C₁- to C₂₀-alkyl, C₁- to C₂₀-alkoxy, C₃- to C₁₀-cycloalkyl, C₂- to C₂₀-alkenyl or C₆- to C₁₀-aryl.

4. Method according to one or more of the preceding claims, characterized in that, during the preparation of the recording material, at least one monomer of Formula (II) has been used 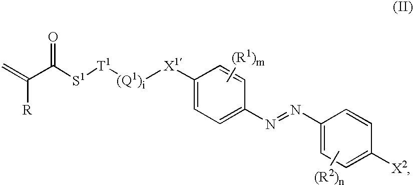
where
R stands for hydrogen or methyl and
the other radicals have the meaning specified in claim 3.

5. Method according to one or more of the claims in which the storage material has a high photosensitivity, preferably ≧0.3 cm²/J, in the wavelength range from 390 nm to 580 nm, the light pulses have a duration of 0.1 to 1000 ns and a pulse energy of between 0.1 and 1000 mJ/cm², and, in addition, the birefringence induced by a reading pulse must be at least 1% of the value that can be achieved as a maximum by monochromatic continuous-wave irradiation with polarized light in the visible wavelength range and the birefringence is greater than 0.03.

6. Method according to one or more of the preceding claims, wherein the writing wavelength is in the absorption range of the recording layer, in particular in the range of high photosensitivity according to one or more of the preceding claims, wherein the reading wavelength is either equal to the writing wavelength or is of longer wavelength, and wherein the chosen intensity is less than 10%, preferably less than 5%, particularly preferably less than 1% of the intensity of the writing laser provided the reading wavelength is in the high-photosensitivity range.

7. Method according to one or more of the preceding claims, wherein polymers or oligomers are used to whose main groups side chains are bound that absorb light of the writing laser.

8. Method according to one or more of the preceding claims, wherein the recording layer has a thickness of 50 to 500 nm.

9. Storage media, prepared according to one or more of the preceding claims.
